(19) United States
(12) Patent Application Publication
(10) Pub. No.: US 2025/0045604 A1
(43) Pub. Date: Feb. 6, 2025

(54) MULTI-MODEL INFERENCING FRAMEWORKS AND APPLICATION PROGRAMMING INTERFACES

(71) Applicant: NVIDIA Corporation, Santa Clara, CA (US)

(72) Inventors: Shekhar Dwivedi, Santa Clara, CA (US); Rahul Choudhury, Livermore, CA (US)

(21) Appl. No.: 18/229,929

(22) Filed: Aug. 3, 2023

(51) Int. Cl. G06N 5/04; G06N 20/00

(52) U.S. Cl. CPC G06N 5/04; G06N 20/00

(57) ABSTRACT

Apparatuses, systems, and frameworks for provisioning of efficient pipelines capable of multi-model inference and data processing, including streaming data applications. The disclosed techniques allow efficient deployment and execution of multiple machine learning using pluggable inference and data processing backends by users without specialized developer experience.

### TECHNICAL FIELD

At least one embodiment pertains to processing resources used to perform and facilitate artificial intelligence. For example, at least one embodiment pertains to efficient deployment of multiple machine learning models.

### BACKGROUND

Machine learning is often used in many settings, such as office and hospital environments, medical imaging, robotic automation, security applications, autonomous transportation, law enforcement, among others. In particular, machine learning has applications in audio and video processing, such as in voice, speech, and object recognition. One popular approach to machine learning involves training a computing system using training data (sounds, images, actions, face expressions, texts, and/or other data) to identify patterns in the data that may facilitate data classification, such as the presence of a particular type of an object within a training image or a particular word within a training speech or text. Training can be supervised or unsupervised. Machine learning models can use various computational algorithms, such as decision tree algorithms (or other rule-based algorithms), artificial neural networks, and the like. After a deployment of a successfully trained machine learning model, new data is input into the trained machine learning model during an inference stage and various target objects, sounds, sentences, actions, an/or any other target patterns can be identified using patterns and features learned during training.

### BRIEF DESCRIPTION OF DRAWINGS

FIG. 1A is a block diagram of an example architecture of a computing system that supports multi-model inference and data processing, in accordance with at least some embodiments;

FIG. 1B illustrates an example inference server capable of supporting multi-model inference and data processing, according to at least one embodiment;

FIG. 2 is a high-level depiction of a multi-model inference and data processing, according to at least one embodiment;

FIG. 3 illustrates schematically a data flow during multi-model inference and data processing, as configured by a data manager, according to at least one embodiment;

FIG. 4 illustrates a processing pipeline of a framework for multi-model inference and data processing, according to at least one embodiment;

FIG. 5 illustrates operations of a processing pipeline that supports multi-model inference and data processing, according to at least one embodiment;

FIG. 6 is a flow diagram of an example method of multi-model inference and data processing, in accordance with at least some embodiments;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment.

### DETAILED DESCRIPTION

Machine learning (ML) has become a staple in a variety of industries and activities where at least some levels of decision-making can be delegated to computer systems. Presently, an increasing number of progressively more complex machine learning models (MLMs) are often applied to processing large amounts of data, including streaming data. In addition to inference processing, the data may initially undergo substantial pre-processing and then undergo additional post-processing, e.g., to be represented in a form suitable for consumption by an end user. For example, a large medical image of a patient's body may first undergo denoising, enhancement, adjustment of contrast and resolution (e.g., downsampling or upsampling), cropping into smaller images that depict individual organs, and so on, before being processed by several MLMs, with individual MLMs trained to perform inference on a particular cropped portion of the large image. The MLMs may diagnose the presence of various pathologies of organs depicted in the respective cropped portions and output inference predictions (classifications), such as types, locations, and severity of the discovered pathologies. The MLM inference outputs may be combined with (e.g., placed back in the context of) the large image, annotated with texts, supplied with dimensions, augmented with references to applicable medical records of the patient, suggestions of the likely diagnoses and/or additional tests/procedures recommended to be scheduled for the patient, and so on. The MLMs used for inference may have a variety of different architectures and inputs. For example, some MLMs may include convolutional neural networks trained to process images, other MLMs may include recurrent or transformer neural networks trained to process a time series of laboratory test results, yet other MLMs may include conversational (language) models trained to collect verbal responses of the patient's self-assessment, and the like. [0 016] Presently, configuring, deploying, and using a diverse set of multiple MLMs (especially MLMs having different functionality and architectures) for processing of complex data, including streaming data, is a very challenging task typically requiring efforts of several code developers with significant expertise in both artificial intelligence (AI) applications and efficient utilization of hardware resources, e.g., central processing units (CPUs), graphics processing units (GPUs), system memory, input/output (IO) devices, and/or the like. A developer has to write code implementing data traffic for each MLM, including management of input data (e.g., storage and destination buffers) and allocation of memory buffers for output data, aggregated data, transient data, e.g., the data that has undergone pre-processing and is awaiting inference processing or the data that is awaiting post-processing, and the like. The developer has to encode execution of each MLM during inference stage, e.g., link data buffers to inference backends (e.g., TensorFlow®, PyTorch®, TensorRT®, ONNX®, and the like) that are to execute the respective MLM, encode the types of processing resources the backends are to use (e.g., one or more CPUs, GPUs, and the like), encode the type of the backend execution (e.g., parallel execution, sequential execution, mixed execution, batched execution), and the like. The developer may further have to encode, using one or more available post-processing backends, various post-processing operations, which may include fragmenting, aggregating, modifying, and/or visualizing data output by different MHLMs, transmitting data to intended recipients, and/or so on. Each inference backend or processing (pre- or post-processing) backend may input data and output data using specific formats that may be different from data formats native to other backends and/or applications. Each inference backend or processing backend may also be configured using a different procedure and have different configuration settings. In some instances, a developer may have to program a backend for sequential execution or parallel execution (e.g., on multiple processors), for CPU execution vs. GPU execution, for floating-point computations vs. integer mode, computations and so on, each option requiring a separate coding. Correspondingly, optimizing deployment and execution of multiple MLMs, which may use different data formats, on multiple backends is often a challenging task for even experienced developers.

Aspects and embodiments of the present disclosure address these and other challenges of the modern technology by providing for methods and systems that enable inference and pre/post-processing of data (including streaming data) using multiple MLMs. In some embodiments, an inference engine is used to configure concurrent inference execution of multiple MLMs, including parallel execution, sequential execution, batch execution, and the like. The inference engine is capable of utilizing one or more inference backends (e.g., TensorFlow®, PyTorch®, TensorRT®, ONNX®, and/or the like) that may be selectively executed on several computational platforms, e.g., CPU platform, GPU (CUDA) platform, combined CPU/GPU platform, and/or the like. The inference engine may include one or more application programming interfaces (APIs) that communicate with backends and allow the inference engine to configure and perform inference execution. The inference engine may further include a user API that facilitates interaction with a user (developer). The user may control inference execution of multiple MLMs using a set of high-level commands, supported by the user API, that concisely and efficiently define how deployment of MLMs and inference of input data is to be performed. More specifically, the set of high-level commands may be used to communicate to the inference engine a set of parameters (configuration inputs), which may include some of the following: identification and storage locations of the MHLMs to be used, identification and storage locations of the input data to be applied to the MLMs, identification of the inference backends to be used with various MLMs, identification of a number format to be used in computations (e.g., integer number, half-precision format, full precision format, and/or the like), execution modes (e.g., parallel processing, batch processing, multi-GPU processing) and/or the like. The set of parameters may further specify how data should be moved along a processing pipeline and between its different stages, e.g., a pre-processing stage, an inference stage, a post-processing stage, storage of the output data and/or transmission of the output data to the end (or next) user of the data, and/or the like. Data propagation through the processing pipeline may be facilitated by a data manager operating in conjunction with the inference engine. Similarly, pre-processing and post-processing of data may be facilitated by a processing engine receiving, via the user API, additional parameters specifying pre-processing operations to be performed on the input data and/or post-processing to be performed on the output data.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### System Architecture

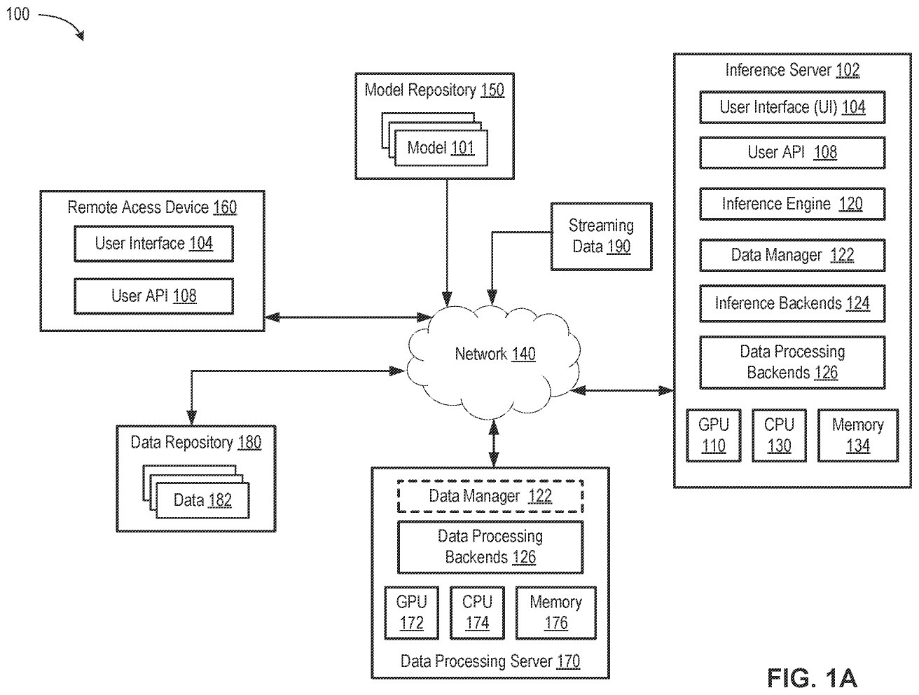

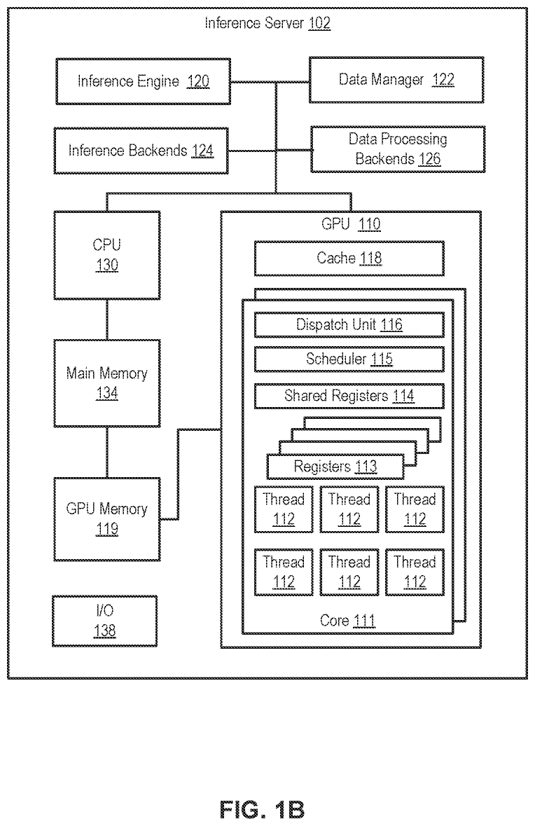

FIG. 1A is a block diagram of an example architecture 100 of a computing system that supports multi-model inference and data processing, in accordance with at least some embodiments. As depicted in FIG. 1A, example architecture 100 may be implemented on multiple computing devices, e.g., inference server 102, remote access device 160, data processing server 170, and so on, and may use multiple storage repositories, including but not limited to a model repository 150 and data repository 180. Any of the servers, storages, modules, and components of example architecture 100 may be implemented using cloud computing. In some embodiments, any of the modules and components of example architecture 100 may be implemented using more or fewer devices than are shown in FIG. 1A. In some embodiments, all modules and components of example architecture 100 may be implemented on a single computing device (e.g., inference server 102), including but not limited to a computing device local to a user of example architecture 100.

Inference server 102 may be or include a desktop computer, a laptop computer, a smartphone, a tablet computer, a server, a computing device that accesses a remote server, a computing device that utilizes a virtualized computing environment, a gaming console, a wearable computer, a smart TV, and/or any combination thereof. A user may have a local or remote (e.g., over a network) access to inference server 102. For example, the user may access inference server 102 via a remote access device 160, which may be any type of computing device referenced above in conjunction with inference server 102, or any other type of computing device, or a combination of multiple computing devices. Inference server 102 may have any number of graphics processing units (GPUs) 110, central processing units (CPUs) 130, parallel processing units (PPUs), data processing units (DPUs), or accelerators, and/or other suitable processing devices capable of performing the techniques described herein. GPU 110 and/or CPU 130 may support any number of virtual CPUs and/or virtual GPUs. Inference server 102 may include any number of memory devices, also referred to simply as memory 134 herein. Inference server 102 may also include network controllers, peripheral devices, and the like. Peripheral devices may include cameras (e.g., video cameras) for capturing images (or sequences of images), microphones for capturing sounds, scanners, sensors, or any other devices for intake of data.

In some embodiments, inference server 102 may include a number of engines and components to facilitate efficient multi-model inference and data processing. A user (customer, end user, developer, data scientist, etc.) may interact with inference server 102 via a user interface (UI) 104, which may include a command line, a graphics-based UI, a web-based UI (e.g., a web browser-accessible interface), a mobile application-based UI, or any combination thereof. UI 104 may display menus, tables, graphs, flowcharts, graphical and/or textual representations of software, dataflows, and workflows. UI 104 may include selectable items, which may enable the user to enter various configuration settings, identify models to be deployed, location of input data to be processed, and/or destinations for output data, e.g., as described in more detail below. User actions and configuration settings entered via UI 104 may be communicated to inference engine 120 and/or a data manager 122 via a user API 108. In some embodiments, UI 104 and user API 108 may be located on remote access device 160 that the user is using to access inference engine 120 and data manager 122. For example, API package with user API 108 and/or user interface 104 may be downloaded to remote access device 160. The downloaded API package may be used to install user API 108 and/or user interface 104 to enable the user to have two-way communication with inference engine 120 and data manager 122.

User API 108 may provide to the user a set of high-level commands that can be understood by inference engine 120 and data manager 122 as instructions to deploy multiple user-specified models 101 (also referred to as MLMs herein) and use the deployed models to evaluate data, which may include data 182 stored in data repository 180 and/or streaming data 190, e.g., data generated at runtime by any sensors, such as imaging sensors, video sensors, audio sensors, physical sensors, chemical sensors, and/or any other suitable sensors, and/or combinations thereof. The high-level commands, made available via user API 108, may include commands that identify locations where models 101 are stored (or temporarily held), commands that identify where data to be input into models 101 is stored or originated (e.g., in case of data streaming), and commands that indicate specific backends to be used with various models. The high-level commands may further include identification of a number format to be used during inference computations (e.g., integer, half-precision, full precision format, etc.), execution modes (e.g., parallel processing, batch processing, multi-GPU processing), and/or the like. The high-level commands may specify how data is to be moved along the processing pipeline (e.g., input→pre-processing→inference→post-processing→storage/streaming pipeline) and where the end user of the output data may be located. Individual high-level commands may be input by the user using statements native to the user API 108. Individual high-level commands may include an operation code recognizable by inference engine 120 or data manager 122 as a request to compile a set of low-level commands to perform one or more user-selected operations. Individual high-level commands may further include one or more parameters specifying how the user-intended operations are to be performed. Compiling the set of operations may include selecting, by inference engine 120, one or more pluggable backends for performing the user-selected operations. Furthermore, inference engine 120 may configure execution of the backends on one or more processing devices (e.g., GPUs 110, CPUs 130, etc.), which may be default processing devices, processing devices selected by inference engine 120, or user-selected processing devices. Some of the high-level commands may cause data manager 122 to configure transfer of data through the processing pipeline, including allocating memory for input data, fetching input data, pre-processing input data, identifying input data shared by multiple models 101 (to avoid storage of multiple copies of the same data), storing inference outputs of models 101, allocating memory for the inference outputs and for final outputs, directing the final outputs to the ultimate consumers of those final outputs, and/or the like.

Backends should be understood as any software resources, packages, toolkits, software development kits (SDKs), which are capable of executing on suitable hardware, including but not limited to one or more GPUs 110, one or more CPUs 130, and any other processing resources. Individual backends may include executable codes, libraries, and configuration files. Backends may include inference backends 124 that perform inference on input data using models 101. Backends may further include data processing backends 126 that should be understood as any software tools performing any processing of data different from model-based inference. Data processing backends 126 may include pre-processing backends and post-processing backends. For example, pre-processing backends may perform any processing of the input data, such as denoising, enhancement, changing resolution and contrast, binarization, cropping, aggregation, re-formatting, de-archiving, compression, and/or the like. Post-processing backends may perform any processing of data that occurs after inference, such as annotation of data, pagination of data, combining data, reformatting of data, compression of data, streaming of data, augmentation of data with other data, including with data output by other models 101 and/or auxiliary data, and/or the like.

In some embodiments, at least some of the functionality of inference server 102 may be supported by (e.g., split between) multiple computing devices. For example, as depicted in FIG. 1A, data processing backends 126 may be located on a separate data processing server 170 and may utilize additional and separate processing and memory resources, e.g., one or more CPU(s) 172, GPU(s) 174, and memory devices 176. Pre- and/or post-processing by data processing backends 126 may be configured and performed by data manager 122, which may be located on inference server 102 or, in some embodiments, on data processing server 170 (as indicated with the dashed box in FIG. 1A).

Models 101 may be pre-trained and stored on inference server 102 or in model repository 150 accessible to inference server 102 over a network 140. Network 140 may be a public network (e.g., the Internet), a private network (e.g., a local area network (LAN), or wide area network (WAN)), a wireless network, a personal area network (PAN), or a combination thereof. Models 101 may include regression algorithms, decision trees, support vector machines, K-means clustering models, neural networks, or any other machine learning algorithms. Neural network MLMs may include convolutional, recurrent, fully-connected, Long Short-Term Memory models, Hopfield, Boltzmann, or any other types of neural networks. Generating MLMs may include setting up an MLM type (e.g., a neural network), architecture, a number of layers of neurons, types of connections between the layers (e.g., fully connected, convolutional, deconvolutional, etc.), the number of nodes within each layer, types of activation functions used in various layers/nodes of the network, types of loss functions used in training of the network, and so on. Generating models 101 may include setting (e.g., randomly) initial parameters (weights, biases) of various nodes of the networks. The generated models 101 may be trained by using training data that may include training input(s) and corresponding target output(s).

For example, for training of speech recognition models, training inputs may include one or more digital sound recordings with utterances of words, phrases, and/or sentences that the MLM is being trained to recognize. Target outputs may include indications of whether the target words and phrases are present in the training inputs. Target outputs may also include transcriptions of the utterances, and so on. In some embodiments, target outputs may include identification of a speaker's intent. For example, a customer calling a food delivery service may express a limited number of intentions (to order food, to check on the status of the order, to cancel the order, etc.) but may do so in a practically unlimited number of ways. Whereas specific words and sentences uttered may not be of much significance, determination of the intent may be important. Accordingly, in such embodiments, target outputs may include a correct category of intent. Similarly, a target output for a training input that includes an utterance of a client calling a customer service phone may be both a transcription of the utterance as well as an indication of an emotional state of the client (e.g., angry, worried, satisfied, etc.). During training of models 101, a training software may identify patterns in training input(s) based on desired target output(s) and train the respective models 101 to perform desired tasks. Predictive utility of the identified patterns may subsequently be verified using additional training input/target output associations before being used, during the inference stage, in future processing of new speeches. For example, upon receiving a new voice message, a trained model 101 may be able to identify that the customer wishes to check on the status of a previously placed order, identify the name of the customer, the order number, and so on.

FIG. 1B illustrates an example inference server 102 capable of supporting multi-model inference and data processing, according to at least one embodiment. In at least one embodiment, inference engine 120, data manager 122, inference backends 124, data processing backends 126, and/or other programs and applications may be executed using one or more GPUs 110 (and/or other parallel processing units (PPUs) or accelerators, such as a deep learning accelerator, a data processing unit (DPU), etc.) and one or more CPUs 130. In at least one embodiment, a GPU 110 includes multiple cores 111, some or all cores being capable of executing multiple threads 112. Some or all cores may run multiple threads 112 concurrently (e.g., in parallel). In at least one embodiment, threads 112 may have access to registers 113. Registers 113 may be thread-specific registers with access to a register restricted to a respective thread. Additionally, shared registers 114 may be accessed by one or more (e.g., all) threads of the core. In at least one embodiment, some or all cores 111 may include a scheduler 115 to distribute computational tasks and processes among different threads 112 of respective core 111. A dispatch unit 116 may implement scheduled tasks on appropriate threads using correct private registers 113 and shared registers 114. Inference server 102 may include input/output component(s) 138 to facilitate exchange of information with one or more users or developers.

In at least one embodiment, GPU 110 may have a (high-speed) cache 118, access to which may be shared by multiple cores 111. Furthermore, inference server 102 may include a GPU memory 119 where GPU 110 may store intermediate and/or final results (outputs) of various computations performed by GPU 110. After completion of a particular task, GPU 110 (or CPU 130) may move the output to (main) memory 134. In at least one embodiment, CPU 130 may execute processes that involve serial computational tasks whereas GPU 110 may execute tasks (such as multiplication of inputs of a neural node by weights and adding biases) that are amenable to parallel processing. In at least one embodiment, inference engine 120 may determine which processes are to be executed on GPU 110 and which processes are to be executed on CPU 130.

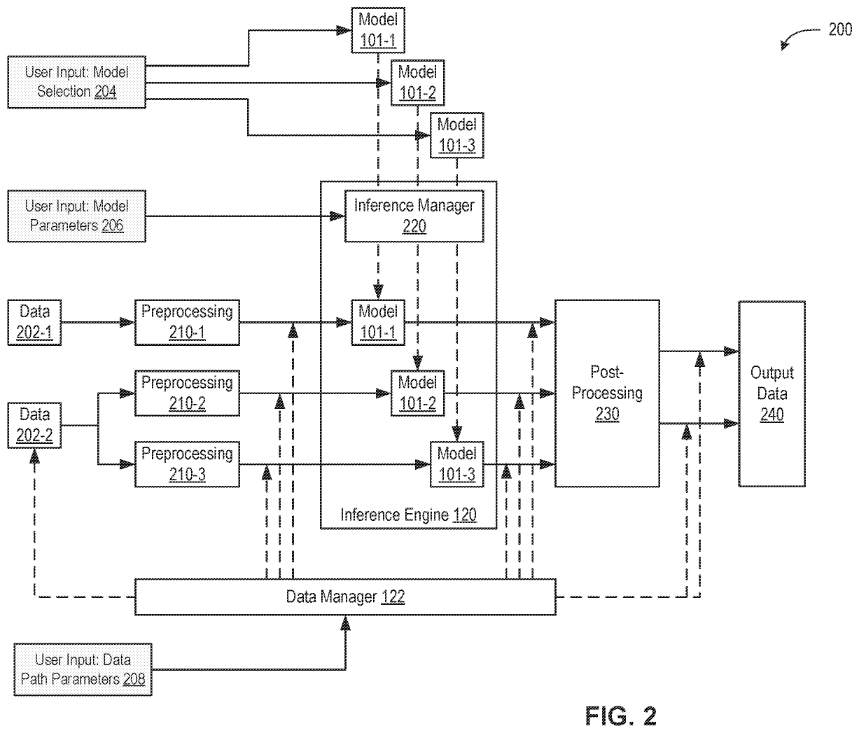

FIG. 2 is a high-level depiction of a multi-model inference and data processing, according to at least one embodiment. For conciseness and ease of viewing, FIG. 2 illustrates processing of two sets of data, namely data 202-1 and 202-2, using three models 101-1, 101-2, and 101-3, but any number of sets of data may be processed using any number of models with the techniques disclosed herein. A user may control multi-model inference and data processing via user configuration inputs indicated with the shaded blocks. In some embodiments, the user configuration inputs may be entered as parameters of a set of high-level commands (statements) made available to the user, e.g., via user API 108 of FIG. 1A. One set of the user configuration inputs may include model selection 204, which identifies memory locations where models 101-j (e.g., models 101-1, 101-2, and 101-3 in this example) are stored, names of the models, and/or other similar identifying information. Storage of models 101-j may be on a local user's computer, on a remote computer/server accessible to the user, on cloud, and/or the like. Models 101-j may be stored in a single storage location or in multiple locations, including multiple computers. Another set of user configuration inputs, entered via corresponding high-level commands (statements), may include model parameters 206. Model parameters 206 may control any aspects of deployment and execution of models 101. In particular, model parameters 206 may indicate to an inference manager 220 of inference engine 120 what inference backends are to be used with various models 101-j, including but not limited to TensorFlow® backends, PyTorch® backends, TensorRT® backends, ONNX® backends, and/or the like. In those instances where the user does not specify an inference backend for a particular model, inference manager 220 may deploy that particular model using a default inference backend. In some embodiments, the default inference backend may be the same for all models deployed and executed by inference engine 120. In some embodiments, the default inference backend may be dependent on a type of the model, e.g., different default inference backends may be set for medical imaging models, speech recognition models, text recognition models, physical/chemical sensor models, and so on. In some embodiments, default inference backends may be set by inference engine developers. In some embodiments, default inference backends may be modified by the user, e.g., by modifying a configuration file of inference manager 220.

Model parameters 206 may further indicate to inference manager 220 a number format to be used in inference computation, including but not limited to an integer number (e.g., INT8 or INT16), half-precision format (FP16), full-precision format (FP32), and/or the like. Model parameters 206 may also indicate to inference manager 220 the hardware platform to be used for execution of various models 101-j by the selected (or default) inference backends. For example, model parameters 206 may indicate that model 101-1 is to be executed on CPU, model 101-2 is to be executed on GPU (e.g., using CUDA® toolkit), and model 101-3 is to be executed on a combination of CPU and GPU. In some embodiments, model parameters 206 may indicate a portion (e.g., subnetwork) of a model to be executed on CPU and a portion of the model to be executed on GPU. Model parameters 206 may also indicate to inference manager 220 execution modes for inference processing of various models 101-j, including sequential processing of all or a subset of models 101-j, parallel processing of all or a subset of models 101-j, or batch processing, e.g., in which models within a batch (group) of models are executed in parallel and different batches of models are executed in series. Selectable execution modes may include inference processing using multiple processors, e.g., multiple CPUs and/or multiple GPUs.

Yet another set of user configuration inputs may include data path parameters 208 that indicate, to data manager 122, how data is to propagate through the inference and data processing pipeline, which may include pre-processing stages 210-1, 210-2, and 210-3 (in this example of three models 101-j), inference engine 120, post-processing stage 230, and/or any other stages as may be used for data evaluation. Data path parameters 208 may inform data manager 122 where initial data, e.g., data 202-1, 202-2, is stored. In some instances, the same data may be input into two or more models 101-j, e.g., the same large medical image may be used as an input into multiple models that specialize in detection of pathology in different organs. In such instances, data manager 122 may identify various models (e.g., models 101-2 and 101-3 in the example of FIG. 2) that take the same common data as inputs (e.g., data 202-2) and use a single memory location to store the common data. The single memory location may be the original storage location of the common data, if the data is stored on the inference server, or may be a buffer on the inference server where the common data may be temporarily copied, if the common data is stored on a different computing device or in a separate data repository.

Data path parameters 208 may further inform data manager 122 how data should be moved along the processing pipeline. More specifically, data path parameters 208 may specify where data 202-1, 202-2, and 202-3 is to be stored after undergoing respective preprocessing stages 210-1, 210-2, 210-3. Data path parameters 208 may further indicate to data manager 122 where the data is to be stored after inference engine 120 has performed (or caused to be performed) inference processing of the data using respective models 101-1, 101-2, and 101-3, and where the stored data may be accessed by a post-processing stage 230. As illustrated schematically by FIG. 2, post-processing stage 230 may combine some data, e.g., as some of the data (data streams) may be consolidated (aggregated). For example, inference outputs of organ-specific models 101-j may be merged into a single map of patient's pathologies and stored as part of output data 240, which may also be delivered to an end user (consumer of the data). Destination storage (or destination stream) for the output data 240 may likewise be identified in data path parameters 208. During pre-processing, inference processing, and/or post-processing, data manager 122 may control data propagation through the pipeline and verify, after each stage, that the data is stored in appropriate buffers, from which the stored data may be correctly fetched by the next stage of the pipeline or by the consumer of output data 240. Additionally, data manager 122 may perform decryption of the data (if the data has been cryptographically protected), decoding data (e.g., if the data has been archived, compressed, or otherwise prepared for storage), and/or reformatting of the data. For example, reformatting data may include transforming the data from a format accessible to a specific preprocessing backend to a format accessible to a specific inference backend, from a format accessible to a particular inference backend to a format accessible to a particular post-processing stage backend, and so on. In some instances, reformatting may involve data (e.g., input tensor) prepared for one inference backend for execution using a different inference backend (e.g., if that different inference backend is selected by the user, as indicated by model parameters 206).

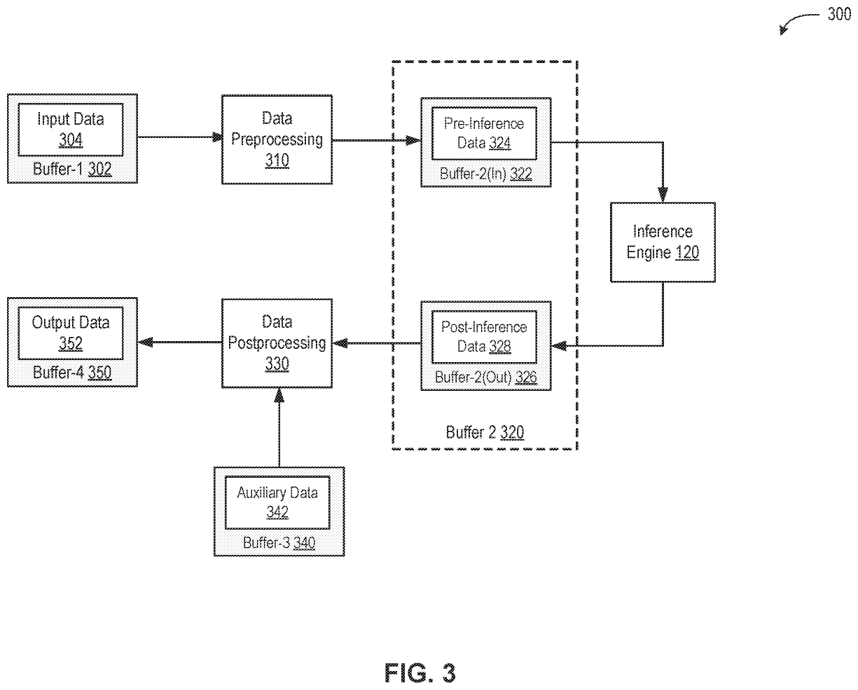

FIG. 3 illustrates schematically a data flow 300 during multi-model inference and data processing, as configured by data manager 122, according to at least one embodiment. Data flow 300 may involve a number of buffers, which should be understood as any suitable memory device or a portion of a memory device, including a high-speed cache, register, dynamic random-access memory, static random-access memory, flip-flop memory, read-only memory, flash memory, and/or the like. It should be understood that individual buffers need not be located within a single memory device or span a contiguous range of memory addresses. Any of the buffers referenced in conjunction with FIG. 3 may be located on multiple memory devices.

Buffer-1 302 may be used to store input data 304, which may include input data into one or more models that are deployed and executed by inference engine 120. For example, input data 304 may include data 202-1 and 202-2 of FIG. 2 (and/or any other similar data). Input data 304 fetched from buffer-1 302 may undergo data preprocessing 310, which may include any of the operations referenced above in conjunction with preprocessing stages 210-j. Preprocessing 310 may further include decrypting, decoding, reformatting of input data 304 (which may be performed prior to or after other preprocessing operations). Following data preprocessing 310, the data may be stored in a buffer-2 320, which may be a buffer used by inference engine 120. Buffer-2 320 may include a buffer-2(In) 322 portion to store pre-inference data 324 and a buffer-2(Out) 326 portion to store post-inference data 328. In some embodiments, at least a part of buffer-2(In) 322 may overlap with some part of buffer-2(Out) 326, e.g., in the instances where post-inference data 328 generated by inference engine 120 (or caused to be generated by inference engine 120) may be stored in the memory space previously occupied by pre-inference data 324, which has already been processed. Post-inference data 328 may undergo data post-processing 330, which may include any of the operations referenced above in conjunction with post-processing stage 230. Post-processing 330 may further include combining post-inference data 328 (or any data derived from post-inference data 328) with any auxiliary data 342 stored in buffer-3 340. Combined output data 352 may then be stored in a buffer-4 350. Buffer-4 350 may then be used to provide output data 352 to an end user, store output data 352 in a more permanent data store, stream output data 352 over a network, and/or the like.

In some embodiments, data flow 300 may be configured by data manager 122 responsive to data path parameters 208 received from the user, with data path parameters 208 identifying some or all buffers 302, 320, 340, and 350. In some embodiments, some or all buffers 302, 320, 340, and 350 may not be identified by data path parameters 208. In the absence of such specific buffer identification, data manager 122 may select default buffers to store the corresponding data.

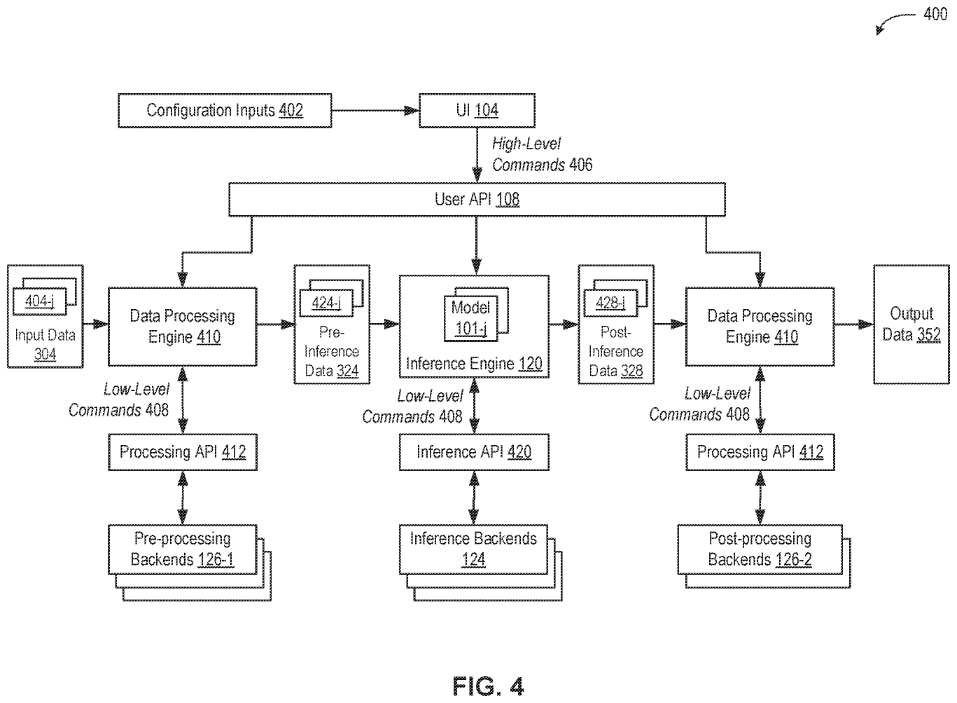

FIG. 4 illustrates a processing pipeline of a framework 400 for multi-model inference and data processing, according to at least one embodiment. Framework 400 may include a user interface (UI) 104 that facilitates user-framework interactions. UI 104 may be or include a command line interface, a browser-based interface, a proprietary graphics interface, and/or any combination thereof. UI 104 may operate as a front-end in user-framework interactions and be facilitated via user API 108. UI 104 may allow a user to input configuration inputs 402, which may include model selection 204, model parameters 206, data path parameters 208 (as disclosed above in conjunction with FIG. 2), and/or any other suitable parameters that may define configuration of the processing pipeline of framework 400. Configuration inputs 402 may be entered as part of high-level commands 406 enabled by user API 108 and relayed to inference engine 120 and/or data processing engine 410. In one illustrative example, model selection 204 configuration inputs may be entered via UI 104 via the following command lines (or as equivalent graphics-selectable inputs):
“Model1”: “/home/m1.onnx”
“Model2”: “/home/m2.engine”
“Model3”: “/office/m3.tf”
. . .
“ModelN”: “/home/mN.pt”
   indicating that model Model1 is located in the /home folder and is an ONNX® model, models Model2 and ModelN are also located in the same folder and are TensorRT® and PyTorch® models, respectively, model Model3 is located in the /office folder and is a TensorFlow® model, and so on.

In one illustrative example, a set of model parameters 206 inputs may include identification of inference backends and may be entered via the following command lines (or as equivalent graphics-selectable inputs):
“Model1”: “ONNX”
“Model2”: “TensorRT”
“Model3”: “TensorFlow”
. . .
“ModelN”: “PyTorch”
   indicating that model Model1 is to be executed using ONNX® inference backend, model Model2 is to be executed using TensorRT® inference backend, model Model3 is to be executed using TensorFlow® inference backend, ModelN is to be executed using PyTorch® inference backend, and so on.

In one illustrative example, a set of model parameters 206 may include identification of hardware platforms for model execution and may be entered via the following command lines (or as equivalent graphics-selectable inputs):
“Model1”: “GPU”
“Model2”: “CPU”
“Model3”: “GPU CPU”
. . .
“ModelN”: “GPU”
   indicating that Model1 and ModelN are to be executed on GPU, Model2 is to be executed on CPU, Model3 is to be executed on both GPU and CPU, and so on.

In one illustrative example, a set of model parameters 206 may include identification of a data format used for model execution and may be entered via the following command lines (or as equivalent graphics-selectable inputs):
“Model1”: “INT8”
“Model2”: “FP16”
“Model3”: “FP32”
. . .
“ModelN”: “INT16”
   indicating that model Model1 is to be executed using the 8-bit integer format, Model2 is to be executed using the single-precision floating point format, Model3 is to be executed using the double-precision floating point format, ModelN is to be executed using the 16-bit integer format, and so on.

In one illustrative example, a set of model parameters 206 may specify various additional configuration parameters, which may be Boolean parameters, e.g., related to global execution of N selected models Model1 . . . ModelN, such as (in one non-limiting example),
“Parallel_Inference”: True/False
“Batch_Inference”: True/False
“Multi-GPU”: True/False
“Float”: True/False
   indicating, respectively, whether parallel execution of multiple models is enabled, whether batch inference is enabled, whether inference using processors (e.g., multiple GPUs in this example) is enabled, whether floating point operations are enabled, and so on.

Although configuration inputs 402 in the above examples specify how inference processing is to be performed, similar commands and parameters may be used to specify performance of pre-processing and post-processing operations, e.g., which processing backends are to be deployed, what type of processing devices (GPUs, CPUs, etc.) are to be used, and/or the like.

In one illustrative example, a set of data path parameters 208 may include mapping of input data 304 to specific models and may be entered as command lines (or as equivalent graphics-selectable inputs):
“Model1”: “Data1-tensor”
“Model2”: “Data2-tensor”
“Model3”: “Data3-tensor”
. . .
“ModelN”: “Data2-tensor”
   indicating that model Model1 is to be used with Data1-tensor input data, Model2 is to be used with Data2-tensor input data, Model3 is to be used with Data3-tensor input data, ModelN is to be used with the same Data2-tensor input data as Model 2, and so on.

In one illustrative example, a set of data path parameters 208 may include mapping of specific models to output data, which may include multiple outputs (e.g., multiple tensors) and may be entered as command lines (or as equivalent graphics-selectable inputs):
“Model1”: [“Output1”, “Output2” ]
“Model2”: [“Output3”, “Output4”, “Output5” ]
. . .
   indicating that model Model1 is to generate output tensors Output1 and Output2, Model2 is to generate output tensors Output3, Output4, and Output5, and so on.

In one illustrative example, a set of data path parameters 208 may include identification of memory buffers to be used for storing initial, intermediate (transient), and output data for various models and may be entered via the following command lines (or as equivalent graphics-selectable inputs):
“Model1”: “DB1, DB2, DB3, DB4”
“Model2”: “DB1, DB2, DB3, DB4”
“Model3”: “DB1, DB5, DB6, DB4”
. . .
“ModelN”: “DB1, DB5, DB6, DB4”
   indicating that model Model1 and Model 2 have a data path that includes buffer DB1 for initial input data, buffer DB2 for pre-inference and post-inference data, buffer DB3 for auxiliary data, DB4 for output data, and further indicating that data path for Model3 and ModelN includes buffer DB5 for pre-inference and post-inference data and buffer DB6 for auxiliary data, and so on. Although in this example a single memory buffer is used to store model inputs, inputs (e.g., tensor inputs) into any given models may be stored in multiple input buffers.

Data processing engine 410 and inference engine 120 may configure the processing pipeline of FIG. 4A as specified by the received configuration inputs 402 (e.g., model selection 204, model parameters 206, data path parameters 208, etc.) may cause. In particular, data processing engine 410 and inference engine 120 may compile high-level commands 406 into low-level commands 408 enabled by processing API 412 (which may interface both preprocessing and postprocessing operations) and inference API 420. More specifically, inference engine 120 may generate low-level commands 408 for specific inference backends 124 selected by configuration inputs 404. Low-level commands 408 may be backend-specific (e.g., different for TensorRT® backends compared with TensorFlow® backends, and the like) and may be provisioned to the inference engine by inference API 420. Although a single inference API 420 (and, similarly, a single processing API 412) is depicted in FIG. 4, a separate API may enable interaction between inference engine 120 and each inference backend 124. This combination of inference engine 120 and inference API(s) 420 enables the use of pluggable inference backends 124 within framework 400.

Similarly, data processing engine 410 may generate low-level commands 408 for specific data pre-processing backends 126-1 and data post-processing backends 126-2 selected by configuration inputs 404. Low-level commands 408 output by data processing engine 410 may also be backend-specific, e.g., different for pre-processing cropping backend compared with pre-processing denoising backend, different for post-processing annotation backend compared with post-processing aggregation backend, and so on.

Pre-processing backends 126-1, inference backends 124, and post-processing backends 126-2 configured via low-level commands 408 may execute various pipeline operations. For example, pre-processing backends 126-1 may transform input data 304 (that may include multiple data inputs 404-j for different models 101-j) into pre-inference data 324 (that includes data 424-j). Inference backends 124 may perform inference on pre-inference data 324 and output post-inference data 328 (that includes data 428-j). Postprocessing backends 126-2 may transform post inference data 328 into output data 352. Data retrieval and storage operations may be performed by data manager 122, e.g., as disclosed above in conjunction with FIG. 2 and FIG. 3.

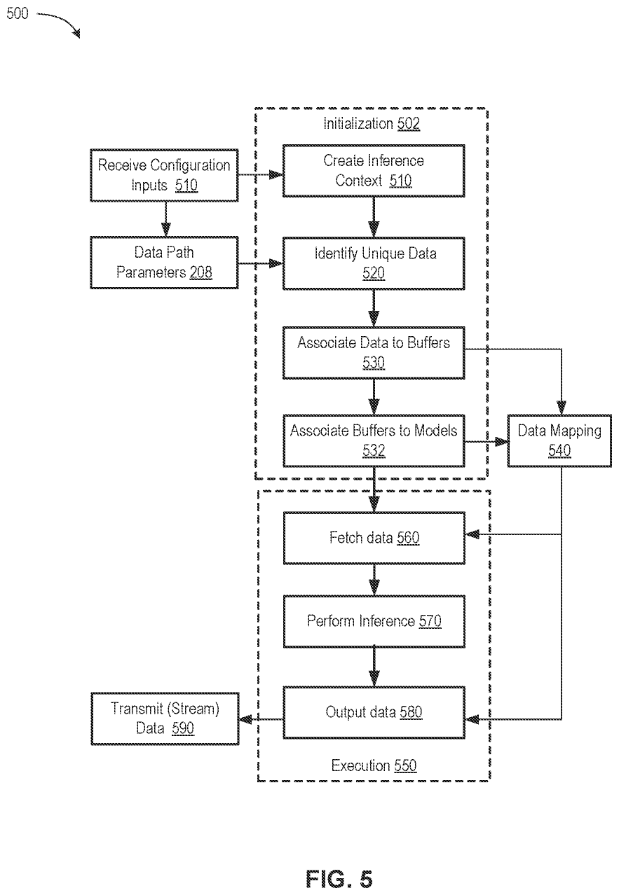

FIG. 5 illustrates operations 500 of a processing pipeline that supports multi-model inference and data processing, according to at least one embodiment. Operations 500 may be performed by inference engine 120 and data manager 122. Operations 500 include receiving configuration inputs (block 510), which may include model selection parameters, model parameters, data path parameters, and the like. Operations 500 may include initialization 502 and execution 550. Initialization 502 may include creating inference context (block 520) using the received configuration inputs. Inference context refers to various information related to the selected models, such as names of the models, types of the models, numbers of inputs and outputs (e.g., numbers of input neurons and output neurons) in the models, sizes of the models (e.g., number of hidden layers and the number of neurons in various layers of the models), types and sizes of buffers to store input data, intermediate (transient), and output data. Inference context may further include information about model conversion. For example, inference context may include identification of an inference backend that is different from a native backend for the model, e.g., a model may be an ONNX® model, but the inference backend selected for the model's execution may be TensorRT® backend, or some other backend. Inference context may also include identification (e.g., names and/or addresses) of input and output tensors for various models, inference backends, and processing devices to be used with various models.

Operations 500 may include identifying data that is used as input into multiple models (e.g., using data path parameters 208) and selecting unique input data (block 520). The unique input data may be associated with (or mapped to) input buffers (block 530) and various input buffers may be associated with (or mapped to) various models (block 532). A single input buffer may be associated with two or more models (in the instances of the same data used as inputs into multiple models). Data-to-buffer and buffer-to-model mappings may be stored (e.g., by data manager 122) as data mapping (block 540).

Execution 550 may include fetching data (block 560) and performing inference (block 570) using selected inference backends and computational resources. Data manager 122 may then store the post-inference data 328 (with a reference to FIG. 4) into an appropriate buffer identified by a user or designated by data manager 122. Post-inference data 328 may include one or more tensors (per each model) that may be specific to the selected backends. Following (optional) post-processing (as described in more detail in conjunction with FIG. 4 above), which may include reformatting post-inference data 328, a final output data (block 580) may be stored in an appropriate buffer (e.g., as may be identified by the user or designated by data manager 122) and/or transmitted (streamed) to a target destination (block 590). In some embodiments, the target destination may be a computing device of the user that provided the configuration inputs. In some embodiments, the target destination may be a different computing device accessible to the same user or a computing device of a different user. For example, the user providing the configuration inputs may be a developer and the user receiving the stream of transmitted data may be a medical professional diagnosing a patient. In some instances, execution 550 may be performed sequentially for each model, e.g., if Parallel_Inference option in model parameters 206 is set to “False.” In some instances, execution 550 may be performed in parallel for all models, e.g., if Parallel_Inference option in model parameters 206 is set to “True.” In some instances, execution 550 may be performed in parallel for all models of individual batches and sequentially for different batches, e.g., if Batch_Inference option is set to “True.”

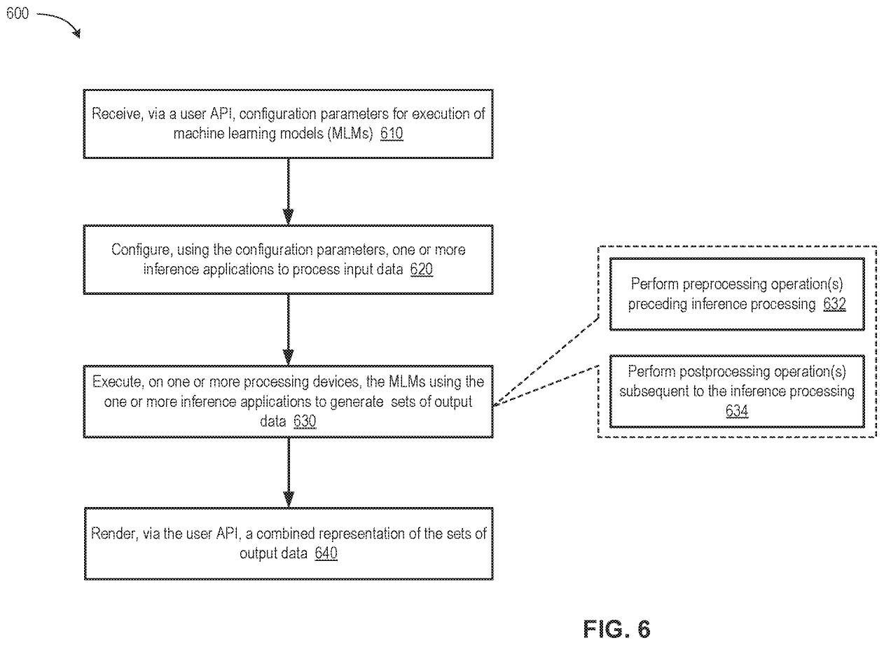

FIG. 6 is a flow diagram of an example method 600 of multi-model inference and data processing, in accordance with at least some embodiments. Method 600 may be performed to deploy MLMs for use in voice recognition, speech recognition, speech synthesis, object detection, object recognition, motion detection, hazard detection, robotics applications, forecasting, and many other contexts and applications where machine learning may be used. In at least one embodiment, method 600 may be performed by processing units of inference server 102 or some other computing device, or a combination of multiple computing devices. Method 600 may be performed by one or more processing units (e.g., CPUs and/or GPUs), which may include (or communicate with) one or more memory devices. In at least one embodiment, method 600 may be performed by multiple processing threads (e.g., CPU threads and/or GPU threads), each thread executing one or more individual functions, routines, subroutines, or operations of the method. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. In at least one embodiment, one or more operations shown in FIG. 6 may not always be performed.

Processing units performing method 600 may receive, at block 610, via a user API, configuration parameters for execution of a plurality of MLMs (e.g., models 101). In some embodiments, at least some of the selected MLMs may be (or include) a neural network model having a plurality of neuron layers. Some of the neural network models may be deep learning neural network models. The configuration parameters (e.g., received with configuration inputs 402 of FIG. 4) may identify storage locations of the plurality of MLMs and storage locations of input data into the plurality of MLMs. The configuration parameters may further identify one or more inference applications (e.g., inference backends 124) for performing inference processing of the input data using the plurality of MLMs. In some embodiments, the configuration parameters further identify one or more processing devices for execution of the plurality of MLMs. In some embodiments, the one or more processing devices may include at least one of a central processing unit (CPU) or a graphics processing unit (GPU).

In some embodiments, the configuration parameters may further identify a number format used for execution of one or more of the plurality of MLMs. For example, the number format may include at least one of an integer format, a single-precision format, or a double-precision format. In some embodiments, the configuration parameters may further identify a type of execution of the plurality of MLMs on the one or more processing devices. For example, the type of execution may include execution of a first MLM of the plurality of MLMs on a plurality of GPUs. The type of execution may also include parallel execution of the first MLM and a second MLM of the plurality of MLMs on the one or more processing devices. The type of execution may further include sequential execution of the first MLM and the second MLM on the one or more processing devices.

In some embodiments, the configuration parameters may further identify at least one storage location for transient data. The transient data may include data output by one or more pre-processing operations that precede the inference processing (e.g., pre-inference data 324). The transient data may also include data input into one or more post-processing operations that are subsequent to the inference processing (e.g., post-inference data 328).

In some embodiments, the configuration parameters may further identify one or more preprocessing operations that precede the inference processing (e.g., operations performed by pre-processing backends 126-1 in FIG. 4) and/or one or more post-processing operations that are subsequent to the inference processing (e.g., operations performed by post-processing backends 126-2 in FIG. 4).

At block 620, method 600 may continue with configuring, using the received configuration parameters, the one or more inference applications to process the input data. In some embodiments, the one or more inference applications may include at least one inference backend capable of being selectively directed to execute an MLM using a GPU and/or a CPU. In some embodiments, the inference backend may be further capable of being selectively directed to execute multiple MLMs sequentially or in parallel. Configuring the one or more inference applications to process the input data may include causing reformatting of the transient data from a first format to a second format. At least one of the first format or the second format may be a format accessible to the one or more inference applications. For example, reformatting of the transient data may be from a first format accessible to one of pre-processing backends 126-1 to a second format accessible to one of inference backends 124. As another example, reformatting of the transient data may be from a first format accessible to one of inference backends 124 to a second format accessible to one of post-processing backends 126-2.

At block 630, method 600 may continue with executing, on one or more processing devices, the plurality of MLMs using the one or more inference applications to generate a plurality of sets of output data. Each MLM of the plurality of MLMs may generate at least one set of output data of the plurality of sets of output data. As illustrated with the callout portion of FIG. 5, executing the plurality of MLMs may also include performing, at block 632, the one or more pre-processing operations that precede the inference processing and performing, at block 634, the one or more post-processing operations that are subsequent to the inference processing. At block 640, method 600 may include rendering, via the user API, a combined representation of the plurality of sets of output data. In some implementations, rendering the combined representation may include displaying the combined representation on a user interface (e.g., UI 104). The combined representation may have a graphical form (e.g., combined graphical representation of objects identified by multiple MLMs), a textual form (e.g., descriptions of classifications performed by multiple MLMs), an audio form, a mixed form (e.g., images combined with text annotations), and/or any other suitable form.

### Inference and Training Logic

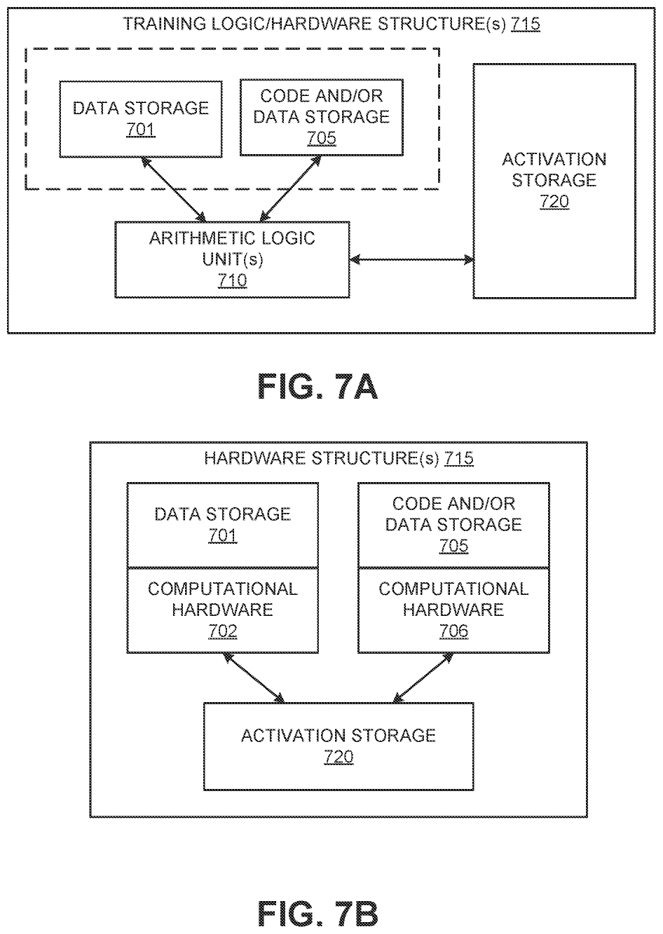

FIG. 7A illustrates inference and/or training logic 715 used to perform inference and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inference in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inference using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inference functions being performed, batch size of data used in inference and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inference in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inference using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inference functions being performed, batch size of data used in inference and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inference and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inference functions being performed, batch size of data used in inference and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware, data processing unit (“DPU”) hardware, or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware, data processing unit (DPU) hardware, or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

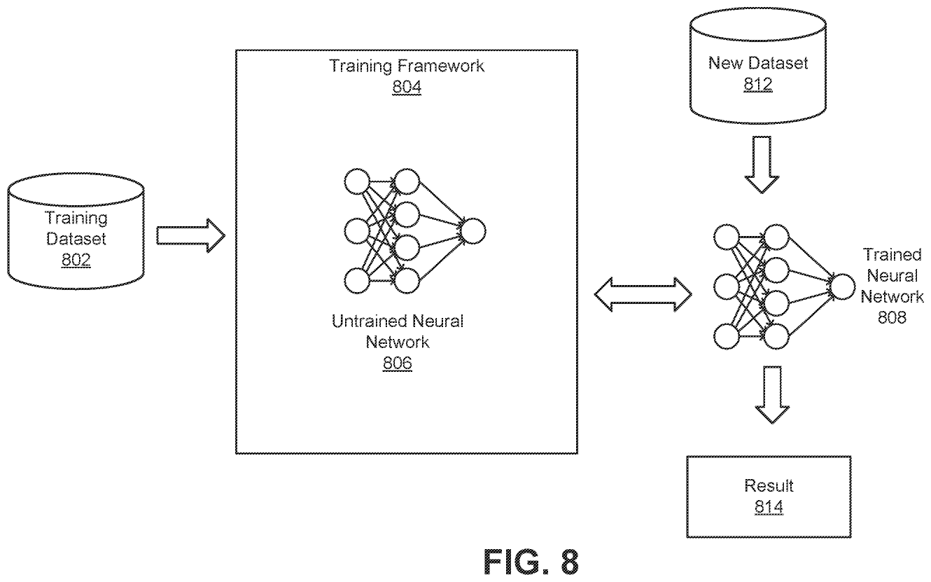

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

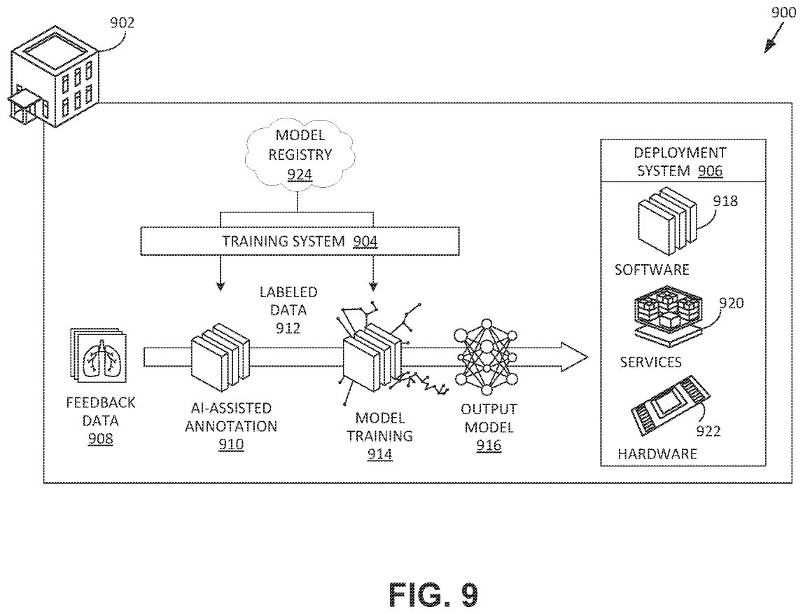

With reference to FIG. 9, FIG. 9 is an example data flow diagram for a process 900 of generating and deploying a processing and inference pipeline, according to at least one embodiment. In at least one embodiment, process 900 may be deployed to perform game name recognition analysis and inference on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some of applications used in advanced processing and inference pipelines may use machine learning models or other AI to perform one or more processing steps. In at least one embodiment, machine learning models may be trained at facility 902 using feedback data 908 (such as feedback data) stored at facility 902 or feedback data 908 from another facility or facilities, or a combination thereof. In at least one embodiment, training system 904 may be used to provide applications, services, and/or other resources for generating working, deployable machine learning models for deployment system 906.

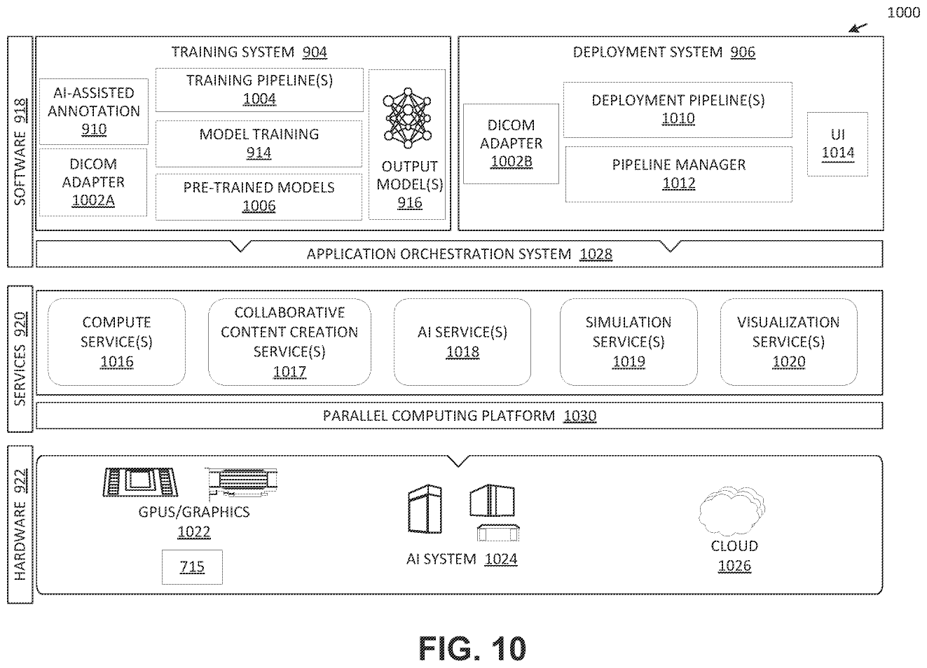

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inference pipeline (e.g., inference, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inference pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inference tasks or other processing tasks of a pipeline to prepare an output data for a next application and/or to prepare output data for transmission and/or use by a user (e.g., as a response to an inference request). In at least one embodiment, inference tasks may be performed by one or more machine learning models, such as trained or deployed neural networks, which may include output models 916 of training system 904.

In at least one embodiment, tasks of data processing pipeline may be encapsulated in a container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers may develop, publish, and store applications (e.g., as containers) for performing processing and/or inference on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity—who provides an inference or image processing request—may browse a container registry and/or model registry 924 for an application, container, dataset, machine learning model, etc., select a desired combination of elements for inclusion in data processing pipeline, and submit an processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel (e.g., using a parallel computing platform 1030 (FIG. 10)). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inference pipeline may be streamlined because each application may call upon a same inference service to perform one or more inference tasks.

In at least one embodiment, hardware 922 may include GPUs, CPUs, DPUs, graphics cards, an AI/deep learning system (e.g., an AI supercomputer, such as NVIDIA's DGX supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, as non-limiting examples. In at least one embodiment, at least some of computing environment of deployment system 906 and/or training system 904 may be executed in a datacenter one or more supercomputers or high performance computing systems, with GPU optimized software (e.g., hardware and software combination of NVIDIA's DGX system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inference pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public IPs that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004 similar to a first example described with respect to FIG. 9 may be used for a first machine learning model, training pipeline 1004 similar to a second example described with respect to FIG. 9 may be used for a second machine learning model, and training pipeline 1004 similar to a third example described with respect to FIG. 9 may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment or embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s) (e.g., facility 902). In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types)—including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, user interface 1014 (or a different user interface) may be used for selecting models for use in deployment system 906, for selecting models for training, or retraining, in training system 904, and/or for otherwise interacting with training system 904.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged by and shared by applications or containers in deployment system 906 may include compute services 1016, AI services 1018, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inference services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inference tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inference using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inference tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inference may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT less than one minute) priority while others may have lower priority (e.g., TAT less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inference on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA and/or QUADRO GPUs) may include any number of GPUs that may be used for executing processing tasks of compute services 1016, AI services 1018, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inference (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inference—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inference, deep learning, machine learning, and/or other artificial intelligence tasks. In at least one embodiment, AI system 1024 (e.g., NVIDIA's DGX) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TENSOR RT), provide an accelerated parallel computing API and platform 1030 (e.g., NVIDIA's CUDA), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry—such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) and/or a data processing unit (“DPU”)—potentially in conjunction with a GPU)—executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving, via a user application programming interface (API), configuration parameters for execution of a plurality of machine learning models (MLMs), wherein the configuration parameters identify:
storage locations of the plurality of MLMs,
storage locations of input data into the plurality of MLMs, and
one or more inference applications for performing inference processing of the input data using the plurality of MLMs;
configuring, using the received configuration parameters, the one or more inference applications to process the input data;
executing, on one or more processing devices, the plurality of MLMs using the one or more inference applications to generate a plurality of sets of output data, wherein each MLM of the plurality of MLMs generates at least one set of output data of the plurality of sets of output data; and
rendering, via the user API, a combined representation of the plurality of sets of output data.

2. The method of claim 1, wherein the configuration parameters further identify:
the one or more processing devices for execution of the plurality of MLMs, wherein the one or more processing devices comprise at least one of a central processing unit (CPU) or a graphics processing unit (GPU).

3. The method of claim 1, wherein the configuration parameters further identify:
a number format used for execution of one or more of the plurality of MLMs, wherein the number format comprises at least one of an integer format, a single-precision format, or a double-precision format.

4. The method of claim 1, wherein the configuration parameters further identify a type of execution of the plurality of MLMs on the one or more processing devices, wherein the type of execution comprises at least one of:
execution of a first MLM of the plurality of MLMs on a plurality of GPUs,
parallel execution of the first MLM and a second MLM of the plurality of MLMs on the one or more processing devices, or
sequential execution of the first MLM and the second MLM on the one or more processing devices.

5. The method of claim 1, wherein the configuration parameters further identify at least one storage location for transient data, wherein the transient data comprises at least one of:
data output by one or more pre-processing operations that precede the inference processing, or
data input into one or more post-processing operations that are subsequent to the inference processing.

6. The method of claim 5, wherein configuring the one or more inference applications to process the input data comprises:
causing reformatting of the transient data from a first format to a second format, wherein at least one of the first format or the second format is a format compatible with the one or more inference applications.

7. The method of claim 1, wherein the configuration parameters further identify at least one of:
one or more pre-processing operations that precede the inference processing, or
one or more post-processing operations that are subsequent to the inference processing.

8. The method of claim 7, wherein executing the plurality of MLMs comprises performing:
the one or more pre-processing operations that precede the inference processing, or
the one or more post-processing operations that are subsequent to the inference processing.

9. The method of claim 1, wherein the one or more inference applications comprise at least one inference backend capable of being selectively directed to execute an MLM using a graphics processing unit (GPU) and/or a central processing unit (CPU).

10. The method of claim 9, wherein the inference backend is further capable of being selectively directed to execute multiple MLMs sequentially or in parallel.

11. A system comprising:
a memory device; and
a processor, communicatively coupled to the memory device, to:
receive, via a user application programming interface (API), configuration parameters for execution of a plurality of machine learning models (MLMs), wherein the configuration parameters identify:
storage locations of the plurality of MLMs,
storage locations of input data into the plurality of MLMs, and
one or more inference applications for performing inference processing of the input data using the plurality of MLMs;
configure, using the received configuration parameters, the one or more inference applications to process the input data;
execute, on one or more processing devices, the plurality of MLMs using the one or more inference applications to generate a plurality of sets of output data, wherein each MLM of the plurality of MLMs generates at least one set of output data of the plurality of sets of output data; and
render, via the user API, a combined representation of the plurality of sets of output data.

12. The system of claim 11, wherein the configuration parameters further identify:
the one or more processing devices for execution of the plurality of MLMs, wherein the one or more processing devices comprise at least one of a central processing unit (CPU) or a graphics processing unit (GPU).

13. The system of claim 11, wherein the configuration parameters further identify:
a number format used for execution of one or more of the plurality of MLMs, wherein the number format comprises at least one of an integer format, a single-precision format, or a double-precision format.

14. The system of claim 11, wherein the configuration parameters further identify a type of execution of the plurality of MLMs on the one or more processing devices, wherein the type of execution comprises at least one of:
execution of a first MLM of the plurality of MLMs on a plurality of GPUs,
parallel execution of the first MLM and a second MLM of the plurality of MLMs on the one or more processing devices, or
sequential execution of the first MLM and the second MLM on the one or more processing devices.

15. The system of claim 11, wherein the configuration parameters further identify at least one storage location for transient data, wherein the transient data comprises at least one of:
data output by one or more pre-processing operations that precede the inference processing, or
data input into one or more post-processing operations that are subsequent to the inference processing.

16. The system of claim 15, wherein to configure the one or more inference applications to process the input data, the processor is to:
cause reformatting of the transient data from a first format to a second format, wherein at least one of the first format or the second format is a format accessible to the one or more inference applications.

17. The system of claim 11, wherein the configuration parameters further identify at least one of:
one or more pre-processing operations that precede the inference processing, or
one or more post-processing operations that are subsequent to the inference processing; and
wherein to execute the plurality of MLMs on one or more processing devices, the processor is to cause the one or more processing devices to perform:
the one or more pre-processing operations that precede the inference processing, or
the one or more post-processing operations that are subsequent to the inference processing.

18. The system of claim 11, wherein the one or more inference applications comprise at least one inference backend capable of being selectively directed to execute an MLM using a graphics processing unit (GPU) and/or a central processing unit (CPU), and wherein the inference backend is further capable of being selectively directed to execute multiple MLMs sequentially or in parallel.

19. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of augmented reality content, virtual reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

20. A processor comprising processing circuitry to perform operations comprising:
receive, via a user application programming interface (API), configuration parameters for execution of a plurality of machine learning models (MLMs), wherein the configuration parameters identify:
storage locations of the plurality of MLMs,
storage locations of input data into the plurality of MLMs, and
one or more inference applications for performing inference processing of the input data using the plurality of MHLMs;
configure, using the received configuration parameters, the one or more inference applications to process the input data;
execute, on one or more processing devices, the plurality of MHLMs using the one or more inference applications to generate a plurality of sets of output data, wherein each MLM of the plurality of MLMs generates at least one set of output data of the plurality of sets of output data; and
render, via the user API, a combined representation of the plurality of sets of output data.
